(19) United States
(12) Patent Application Publication
(10) Pub. No.: US 2008/0219261 A1
(43) Pub. Date: Sep. 11, 2008

(54) Apparatus and method for processing data streams

(76) Inventors: Yeejang James Lin, San Jose, CA (US); Jo-Yu Wu, Fremont, CA (US); Yao-Min Chen, San Jose, CA (US)

Correspondence Address: Wang Law Firm, Inc., 4989 Peachtree Parkway,, Suite 200, Norcross, GA, 30092, US

(21) Appl. No.: 11/714,412

(22) Filed: Mar. 6, 2007

(51) Int. Cl. H04L 12/28

(52) U.S. Cl. 370/392

(57) ABSTRACT

A system and method for processing data streams is disclosed. The system receives data packets for data streams, screen the data packets for searched patterns, and forward the data packets for their respective stream processing. Generally, the data packet is scanned for viruses before being forwarded for further processing. When an out-of-order data packet is received, a copy is made and the data packet is forwarded without being scanned. When a delayed data packet is received, it is scanned for virus along with the saved copy of the out-of-order data packet. If a virus is detected, the delayed packet is dropped and its connection reset. If no virus is found, the delayed packet is forwarded for further processing.

### BACKGROUND OF THE INVENTION

1. Field of the Invention

The present invention generally relates to data communications, and more specifically, relates to a system and method for providing security during data transfers.

2. Description of the Related Art

Data transfer from one computer to another computer as data packets that travel through one or more data networks. A data packet consists of three elements: the first element is a header, which marks the beginning of the packet; the second element is the payload, which contains the information to be carried in the packet; the third element is a trailer, which marks the end of the packet. A good analogy is to consider a packet to be like a letter: the header is like the envelope, and the data area is whatever the person puts inside the envelope. A difference, however, is that some networks can break a larger packet into smaller packets when necessary.

A large chunk of data is normally broken into smaller packets and then sent from one origination computer to a destination computer. The transmission of these data packets is not guaranteed and not error free. At the destination computer, the data packets are received and reassembled, and data is recovered.

Normally, after the data is reassembled, it is checked against viruses or searched patterns. Since a virus or searched pattern may spread to multiple data packets, traditionally, the data is reassembled and checked by a server before being forwarded to its destination. FIG. 1 illustrates a traditional architecture 100 for a data transfer. The data is sent from a source 102 to a destination 106 passing through a server 104. A large data may be divided into smaller data packets at the source 102, reassembled by the server 104, checked against viruses at the server 104, and forwarded to the destination 106.

FIG. 2 illustrates a traditional architecture 200 for checking viruses and patterns. The architecture reflects s store-and-forward approach, in which the data packets are received by a receiving unit 202 and placed in a temporary storage unit 204 until all the data packets for a particular data stream are received. After the data stream is complete and reassembled, it is forwarded to a processor 206 for virus and pattern checking. If the data stream is found free of viruses or searched patterns, the data stream is then forwarded to the proper application. While the data stream is not complete, it is placed in the temporary storage unit 204.

Because the data packets are placed in the temporary storage unit and the virus checking and pattern searching processes do not start until all the data packets are received, the virus checking and pattern searching processes are delayed and additional hardware and system resources are required to handle the temporary storage.

Besides the delay caused by the temporary storage, the traditional architecture breaks the connection between the source and the destination into two separate connections: one connection from the source to a gate server where the virus and pattern checking is performed and another connection from the gate server to the destination. Some approaches have eliminated the need for the temporary storage, but these approaches still break one original connection into two connections. Therefore, it is desirous to have an apparatus and method that enable screening and forward of incoming data as the data packets arrive, and it is to such apparatus and method the present invention is primarily directed.

### SUMMARY OF THE INVENTION

Briefly described, the apparatus and method of the invention enables an efficient screening of searched patterns, including viruses, with a cut through approach instead of a store-and-forward approach. In one embodiment, there is provided a method for searching predefined at least one pattern in data packets received from a data network. The method includes receiving a data packet from the data network, and retrieving data information from the received data packet. The data information includes byte offset information and connection information. The method also includes retrieving a state information for a connection corresponding to the connection information and the state information includes last processed byte information and last byte forwarded information. If the byte offset information is an expected byte offset from the last processed byte information, then the method includes searching the received data packet for the at least one pattern. If the byte offset information is not the expected byte offset from the last processed byte information, then the method includes forwarding the received data packet to a receiving process without searching the at least one pattern.

In another embodiment, there is provided an apparatus for searching predefined at least one pattern in data packets received from a data network. The apparatus includes a receiving unit for receiving a data packet from a data network, wherein the data packet being identified with a connection, and a storage unit for storing state information for the connection. The apparatus also includes a processing unit capable of retrieving from the received data packet data information that includes byte offset information and connection information, retrieving the state information corresponding to the connection information, the state information including last processed byte information and last byte forwarded information. The processing unit also being capable of, if the byte offset information is an expected byte offset from the last processed byte information, searching the received data packet for the at least one pattern, and, if the byte offset information is not the expected byte offset from the last processed byte information, forwarding the received data packet to a receiving process without searching the at least one pattern.

The present system and methods are therefore advantageous as they enable quick identification of possible computer viruses in a data communication system. Other advantages and features of the present invention will become apparent after review of the hereinafter set forth in Brief Description of the Drawings, Detailed Description of the Invention, and the Claims.

### BRIEF DESCRIPTION OF THE DRAWINGS

FIG. 1 depicts a prior art schematic for a data flow process.

FIG. 2 illustrates a prior art virus scanning architecture.

FIG. 3 illustrates an architecture for a pattern searching system.

FIG. 4 illustrates a flowchart for a pattern searching process.

FIG. 5 illustrates architecture of a server according to one embodiment of the invention.

FIG. 6 illustrates an exemplary state information.

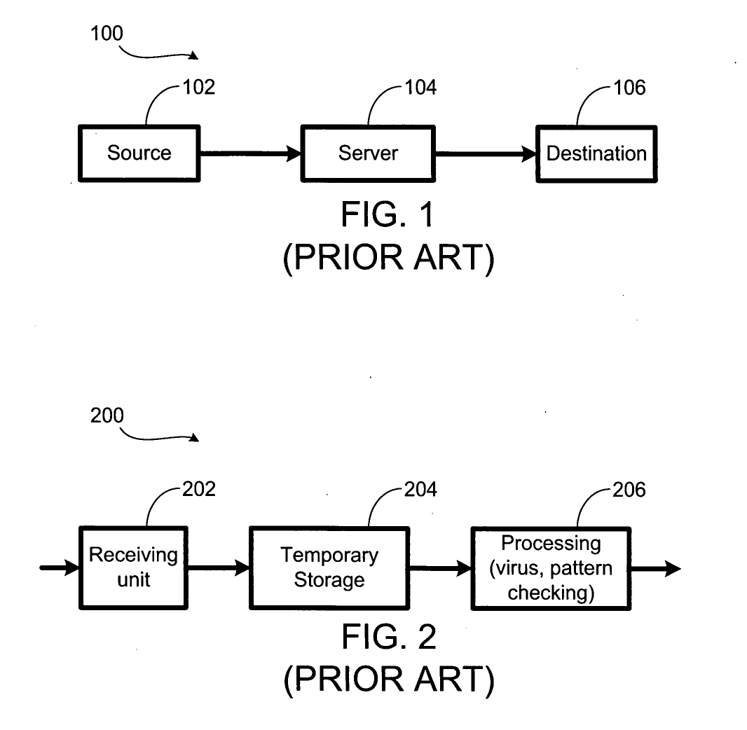

### DETAILED DESCRIPTION OF THE INVENTION

In this description, the term “application” as used herein is intended to encompass executable and nonexecutable software files, raw data, aggregated data, patches, and other code segments. The term “exemplary” is meant only as an example, and does not indicate any preference for the embodiment or elements described. The terms “system” and “server” are used interchangeably. Further, like numerals refer to like elements throughout the several views, and the articles “a” and “the” includes plural references, unless otherwise specified in the description.

In overview, the system and method according to the invention provide an efficient processing of data streams based on a cut-through approach. The system receives data packets for data streams, screen the data packets for searched patterns without changing the data in the data packets into a file, and forward the data packets for their respective stream processing without breaking the original connection into multiple connections. When a large file is transmitted from one computer system (server) to another computer system (server), it is transmitted through multiple data packets. The data packets are transmitted as a data stream between the origination system and the destination system, passing through a gate server. After the data packets are received at the gate server, the data from the data packets are scanned for viruses and then forwarded to the destination where the data are reassembled and the file restored. During the data transfer, each data packet contains an offset information indicating its relative position to the first data byte in a stream of data packet and the offset information is used during the reassembly of the file at the destination server. Before the data packets are forwarded to the destination server, the gate server checks if they contain any virus or searched pattern. After the data packets are searched, they are sent to the destination server for displaying, executing, or otherwise processing. It is understood by those skilled in the art that the gate server and the destination server may be different processes residing on a single hardware server.

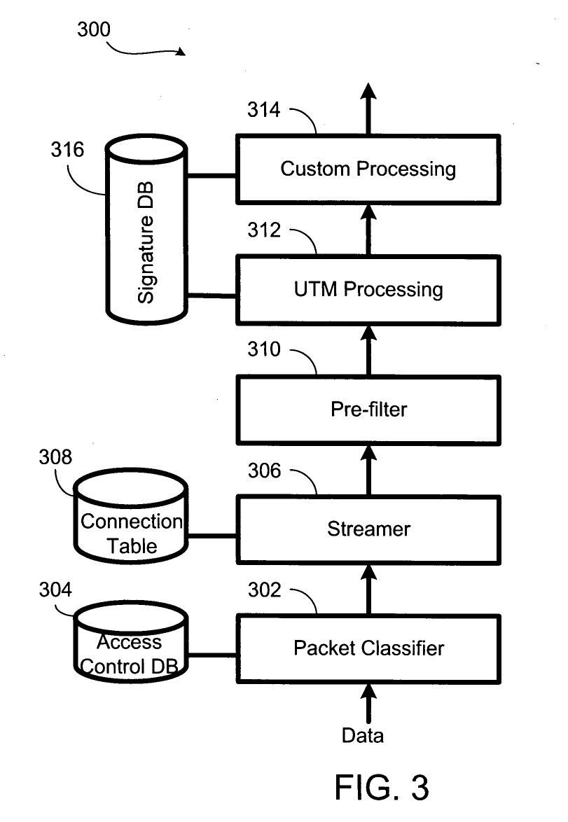

FIG. 3 depicts an architecture 300 for a pattern searching process according to one embodiment of the invention. The data packets are received by a packet classifier 302 from a data network. The data packets may be transmitted using different protocols, such as TCP/IP, UDP, etc. The network may be wired or wireless. After a data packet is received, the data packet is analyzed against policies in an access control database 304. The access control database 304 has access policies that control the flow of data packets. Data packets that violate any of policies will not be processed or forwarded. Each data packet may include the information, such as the Internet Protocol (IP) address and port of the origination system, the IP address and port of the destination system, and the protocol used. This information is used to identify a connection to which the data packet is associated and the connection is used to compare with the policies in the access control database 304. A policy may dictate that all data packets from an originating system or a particular connection are banned; therefore, no connection will be established for data packets coming from that originating system or connection. Matching a policy may also result in a data packet be forwarded directly for separate processing. For example, a data packet that contains a “ping” request may be forwarded directly without any further screening.

When a first data packet of a connection is received by the packet classifier 302, the packet classifier 302 checks if the data packet's connection is in a connection table 308. If the data packet 's connection is not in the connection table, the packet classifier 302 checks if there is any policy against establishing a connection for the data packet. The packet classifier 302 may also check some internal information regarding this possible connection. The internal information may include historical data regarding requests from the source or destination of this connection and the past behavior of the source or destination of this connection. If the packet classifier 302 determines it is safe to establish a connection for this data packet, an entry with the connection information (the IP address and port of the origination system, the IP address and port of the destination system, and the protocol) of this data packet is added to the connection table 308. A simpler checking will be performed by the packet classifier 302 on subsequent data packets from the same data stream. The packet classifier 302 checks whether a subsequent data packet is for a data stream that has an established connection. Since there is a connection established for the subsequent data packet, the data packet is forwarded directly to streamer 306.

After policy checking by the packet classifier 302, the data packet is forwarded to a streamer 306. The streamer 306 is responsible for checking the content of data packets and forwarding them to appropriate connections. Each data transfer between the origination system and the destination system is assigned a connection, and each connection is identified by, among others, the origination IP address and port number and the destination IP address and port number. Instead of waiting for all the data packets related to one connection to arrive and then check their contents for particular searched patterns as is in the traditional store-and-forward approach, the streamer 306 adopts the cut-through approach and searches the content of each data packet as the data packets are received without changing their format. Since, it is possible that a searched pattern may span over multiple data packets and checking of any one single data packet will not reveal the searched pattern, the streamer 306 processes a data packet, saves its state information, and forwards the data packet with a header that reflects its original source and destination to other processor or process for further processing. The state information saved is used to process subsequent data packets received for the same connection. Other processor or process may include pre-filter 310 for virus screening, unified threat management processor 312 for preventive protection and blocking of attacks and unauthorized accesses, and any custom processing 314 that a client may have. It is understood by those skilled in the art that different functions and processes illustrated in FIG. 3 may be performed by different processes in one single hardware server.

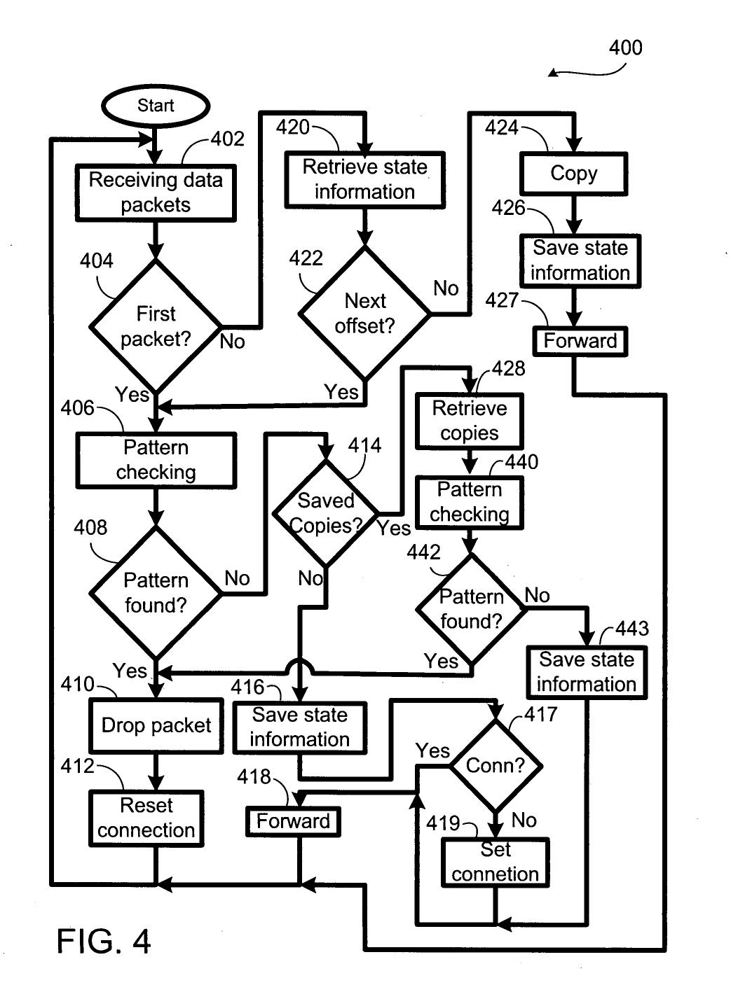

FIG. 4 is a flow chart 400 for a streamer process. When a data packet is received, step 402, it is checked whether it is the first data packet of a connection, step 404. The data packet is checked while it remains in the same memory location where it was placed initially. The header and trailers are not stripped, such that the data packet can be forwarded with its original header to its destination after been successfully processed by the streamer. By keeping the data packet in the same memory location without copying it to different memory locations or registers, the usage of system resources can be minimized and the stream processing can be sped up efficiently. By keeping the original header, no new connection is created and the processing at the stream is transparent to the rest of the system. The connection checking is done by checking whether there is a corresponding connection entry in the connection table 308. If there is no entry for the connection, then the data packet is the first data packet of a connection. If the data packet is the first of its connection, it is checked against a set of searched patterns, step 406. The searched patterns may include known virus and other patterns of interested (for example, indication of some confidential information or restrictive markers placed in a file by a user). It is also possible that a searched pattern is small in size that it is fully contained in one single data packet, and in this case, the searched pattern will be found, step 408. After finding a searched pattern, the server can drop the data packet, step 410, or take some other administrative step, and reset or refuse to establish the connection, step 412. When a connection is reset, a reset message will be sent to both the source and destination of the connection to force a premature abort of the connection. It is understood by those skilled in the art that other ways to reset connections may also be deployed.

If no searched pattern is found, the server will check whether there is any copy of prior data packets for the same connection saved. Copies of prior data packets may be saved under the scenario that will be explained later. Since it is the first data packet of the connection, there is no saved copy and the state information of the connection will be saved, step 416. The state information includes the last processed byte information and copies of the last few bytes forwarded information. The server will check if there is a connection established, step 417. If yes, the data packet is forwarded to another process, step 418; if not, a connection entry created in the connection table, step 419. It is understood by those skilled in the art that each connection may be used for transfer for multiple files and data streams. After the connection is no longer needed, the system will remove (tear down) the connection in a normal manner.

When a subsequent data packet arrives, the server checks its connection information and finds a connection entry for the data packet. After finding the entry for the connection, the server retrieves the state information for the connection, step 420, and includes the last few bytes of the last data packet in the search for virus and searched patterns. It is checked whether the data packet received contains next offset bytes, i.e., if the last byte processed in the last data packet was byte 400, it is checked if the current packet contains byte 401. If the data packet received is the expected next data packet, i.e., containing next offset bytes, the normal processing continues through step 406, where it is checked whether the data packet contains any searched patterns.

It is possible that a newly received data packet contains repeated data that have been previously sent and an example of such retransmission happens when a previously received and forwarded data have been dropped or lost for some reason and a retransmission request is sent to the originating server. For example, it is possible that the last byte processed in the last data packet is byte 400 and the newly received data packets contain bytes 301-500. In this case, some of the received data are repeated and only half of the received data are new data. The server recognizes the situation and will only search the new data.

If no searched pattern is found, the server checks whether there is any copy of prior data packets saved. Since a subsequent data packet is being processed, there is no saved copy; the state information of the data packet is saved and the data packet forwarded.

If some subsequent data packets are delayed and an out-of-order data packet is received, the byte offset in the out-of-order data packet will not match the expected offset. Nonetheless, a copy of the data packet is made, step 424, and the state information is saved, step 426. The data packet is forwarded, step 427. The out-of-order data packet will be fully checked when a delayed data packet is received.

When a delayed data packet is received, the state information for the connection is retrieved, step 420, and the server verifies that the byte offset for the delayed data packet is the next offset byte. The server also checks if the data in the delayed data packet contains any searched pattern. If the data in the delayed data packet contains the next offset byte and does not contain any searched pattern, then the server checks if there is any copy of out-of-order data packets saved, step 414. After retrieving saved copy of the out-of-order data packets, step 428, the server then proceeds to check for searched patterns in the out-of-order data packet using the saved copies, step 440. There can be copies of several sets of the out-of-order data packets and step 428 retrieves copies of the first set of sequential data packets. If a searched pattern is found, the delayed data packet is dropped, step 410, and the connection reset, step 412. If no searched pattern is found, the server saves the state information, step 443, and forwards the delayed data packet, step 418. The process continues until the last data packet for the data stream is received and then the connection is reset.

The following is an exemplary description of one embodiment of the invention. A user surfs the Internet and clicks a link to an audio file listed on one website to download a song. The request is sent to the hosting server, which sends the audio file to the requesting server. The audio file is packed into multiple data packets and sent over the Internet to the user's server. For easy comprehension, it is assumed that the audio file is packed into 10 data packets and each data packet having a payload of 100 bytes of data. It is understood by those skilled in the art that a file may be packed into a plurality of data packets and each data packet may contain different number of bytes of data. Each data packet may also contain a byte offset information indicating the byte offset relative to the first byte of the file. It is also assumed that data packets 1-3, 5-6, and 8-10 are received in order and data packets 4 and 7 are delayed.

After the data packet 1 is received and goes through the policy checking, the server checks its connection information and realizes that there is no connection entry in the connection table. The data packet 1 is the first data packet for the data stream for the audio file. The server checks whether there is any virus or prohibited pattern. If the server finds any virus or searched pattern, the data packet 1 will be dropped and connection refused. If the connection is refused, the server will take appropriate action to notify the sending server and/or requesting server as described above.

Assuming there is no virus or other prohibited pattern in the data packet 1, the server checks whether there is any saved and unprocessed data packets. This checking may be omitted giving the fact that the data packet 1 is the first data packet. Finding no saved and unprocessed data packets, the server saves the state information, creates a connection entry in the connection table, and forwards the data packet to the requesting server. The state information may include, among others, the last byte processed by the server (byte 100), the byte forwarded by the server (byte 100), and copy of last few bytes of data. The state information will be used when processing subsequent data packets. It is appreciated by those skilled in the art that the last byte processed by the server and the last byte forwarded by the server may be a range instead of a single byte identification, e.g., the last byte forwarded may be bytes 301-500 instead of byte 500 and similarly, the last byte processed maybe bytes 1-100 instead of byte 100.

When data packet 2 arrives, the server checks its connection information and finds a connection entry. The server then retrieves the state information associated with the connection entry. The server then proceeds to compare the state information with the data packet 2. The state information indicates that the last byte processed was byte 100 and the last byte forwarded was also byte 100. Since the byte offset information in data packet 2 indicates byte 101-200 are available, the server uses the copy of last few bytes of data from data packet 1 to continue to check for virus and searched patterns. After finding none, the server saves the state information of the connection, which now indicates the last by process is byte 200 and the byte forwarded is also byte 200. The last few bytes of data packet 2 are saved now. The process is repeated for data packet 3.

After data packet 3, data packet 5 is received instead of data packet 4. The server finds the connection entry, retrieves the state information, and realizes the data in data packet 5 is not the expected next offset. The state information indicates the last byte processed being byte 300 and the byte information from data packet 5 indicates bytes 401-500 are now available. The server makes a copy of data packet 5, saves the state information, and forwards data packet 5 to the requesting server. The state information now indicates that the last byte processed is still byte 300, but the last byte offset forwarded is byte 500. The last few bytes of data saved are still those from data packet 3.

After data packet 5, data packet 6 is received and the server retrieves the state information and checks it against the data in data packet 6. Again, the byte information from data packet 6 indicates bytes 501-600 are available, but the state information indicates the last byte processed is byte 300. Similarly, the server updates the state information. The state information now indicates that the last byte processed is still byte 300, but the last byte offset forwarded is byte 600. The last few bytes of data saved are still those from data packet 3.

According to the assumption, data packet 7 is delayed and not received. Data packets 8-10 are received, copied, processed, and forwarded to the requesting server. After processing data packet 8-10, the state information will indicate that the last byte processed is still byte 300, but the last byte offset forwarded is byte 1000. The last few bytes of data saved are still those from data packet 3.

After a delay, data packet 4 is received by the server. The server finds the connection entry and retrieves the state information associated with the connection entry. The server checks the data in data packet 4 against the saved state information. The data in data packet 4 indicates that bytes 401-500 are now available, which matches the expected next offset. The server retrieves the last few bytes saved, which are bytes from data packet 3, and use these last few bytes when searching for virus and searched patterns. If a virus or pattern is found, data packet 4 is dropped and the connection reset. If no virus or pattern is found, the server retrieves the copies of the first set of sequential data packets, which are data packets 5-6. The server proceeds to check for virus and searched patterns using information from data packets 4, 5, and 6. Since no virus is found, the server checks the last byte processed, which is now byte 600 from data packet 6. Since the expected byte byte 601 is missing it is safe to forward data packet 4. So, data packet 4 is forwarded. The state information is updated. Now, the last processed byte is shown as byte 600, the last byte forwarded is still 1000, and the last few bytes saved are from data packet 6. Because data packet 7 is still missing, the destination server will not process the audio file even after receiving data packet 4.

Finally, data packet 7 is received. The server checks data packet 7's connection information, finds the connection entry in the connection table, and retrieves the state information. The server checks the data in data packet 7 against the saved state information. Since the data in data packet 7 indicates that bytes 601-700 are now available and the last processed byte is byte 600, the data in data packet 7 can be processed. The server retrieves the last few bytes saved, which are bytes from data packet 6, and use these last few bytes when searching for virus and searched patterns. If a virus or pattern is found, data packet 7 is dropped and the connection reset. If no virus or pattern is found, the server retrieves the copies of the first set of sequential data packets, which are data packets 8-10. The server proceeds to check for virus and searched patterns using information from data packets 7, 8, 9, and 10. After checking for virus and searched patterns and if no virus or searched patterns is found, the server can safely forward data packet 7 to the destination server since the last byte processed has reached the last byte forwarded; that is, both are now 1000. If a virus or searched pattern is found, the data packet 7 is dropped and the connection is reset.

For the same example above, it is described below the scenario when data packet 7 is received before data packet 4. When data packet 7 is received, the server checks the data information and sees that bytes 601-700 are now available. However, the state information retrieved indicates the last processed byte is 300; therefore, a copy of data packet 7 is made, the data packet 7 is forwarded, and the state information now indicates that the last byte processed is still byte 300, the last byte forwarded is 1000, and out-of-order bytes include 401-1000. When the delayed data packet 4 is finally received, the server retrieves the state information and verifies that the last processed byte and the data information from data packet 4 match, the server then proceeds to check for viruses and searched patterns on data packet 4. The server also retrieves the copies of saved data packets and scans those data for viruses and searched patterns. If no virus or searched pattern is found after byte 1000 is processed, then data packet 4 is forwarded since the last byte processed now reaches the last byte forwarded. If a virus or searched pattern is found, data packet 4 is dropped and the connection reset.

From the above example and FIG. 4, it can be easily seen that the method and apparatus predicated by the invention are based on byte processing instead of file process, i.e., there is no need to convert the data from the received data packets into a file format before being processed. Because the processing is done on the byte basis, there is no need to convert the data into different format and copying the data from the kernel memory space of the operating system running on the server to the user memory space on the server. Elimination of data conversion and data copy make the process of scanning for virus and searched patterns faster and more efficient.

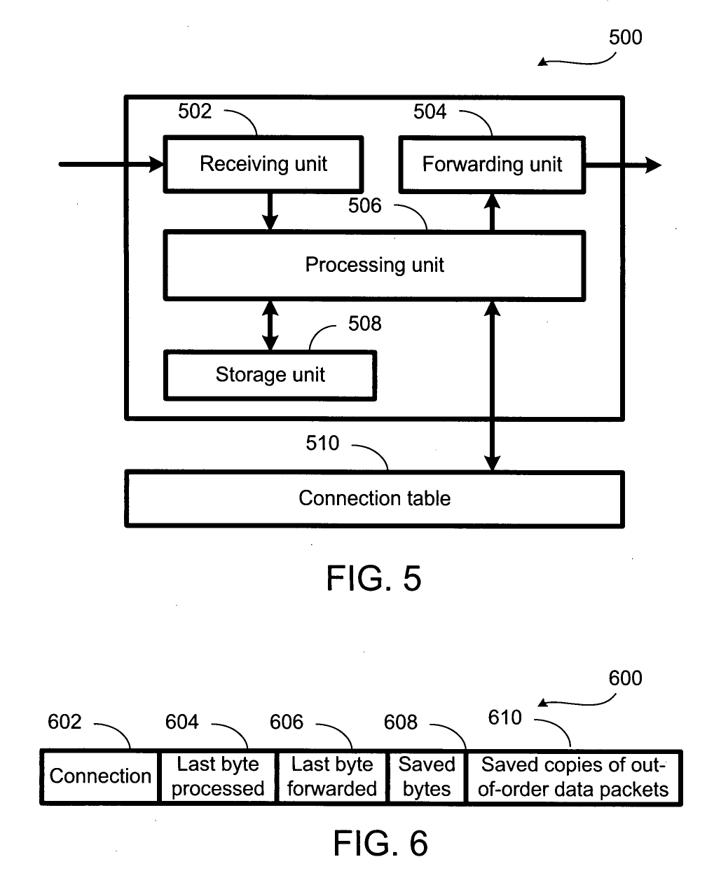

FIG. 5 illustrates architecture 500 of a server according to one embodiment of the invention. The server includes a receiving unit 502 for receiving data packets from a data network, a forwarding unit 504 for forwarding data packets to other processor, a processing unit 506 for scanning the data packets for viruses and searched patterns, and a storage unit 508 for storing state information. The processing unit 506 also has access to a connection table 510, which may also be internal to the server. Alternatively, the connection table may be residing in the storage unit 508. The receiving unit 502 and the forwarding unit 504 may be a single combined unit capable of dual functions. FIG. 6 illustrates an exemplary format 600 for a state information. The state information is identified by a connection 602, information on the last processed byte 604, information on the last byte forwarded 606, saved bytes 608, and copies of out-of-order data packets 610.

Thought the description and the example for searching virus in an incoming data packet, the invention is equally applicable for searching a particular pattern on outgoing data packets. Searching the outgoing data packet for predefined patterns is particularly useful to prevent unauthorized transmission of confidential or secretive information by employees of any organization. The organization may embed some secret pattern in all confidential information and use a system according to the invention to prevent any unauthorized release of the confidential information.

In view of the method being executable on networking devices and servers, the method can be performed by a program resident in a computer readable medium, where the program directs a server or other computer device having a computer platform to perform the steps of the method. The computer readable medium can be the memory of the server, or can be in a connective database. Further, the computer readable medium can be in a secondary storage media that is loadable onto a networking computer platform, such as a magnetic disk or tape, optical disk, hard disk, flash memory, or other storage media as is known in the art.

In the context of FIG. 4, the steps illustrated do not require or imply any particular order of actions. The actions may be executed in sequence or in parallel. The method may be implemented, for example, by operating portion(s) of a server device, such as a network router or network server, to execute a sequence of machine-readable instructions. The instructions can reside in various types of signal-bearing or data storage primary, secondary, or tertiary media. The media may comprise, for example, RAM (not shown) accessible by, or residing within, the components of the network device. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated.

What is claimed is:

1. A method for searching predefined at least one pattern in data packets received from a data network, comprising the steps of:
receiving a data packet from the data network;
retrieving data information from the received data packet, the data information including byte offset information and connection information;
retrieving a state information for a connection corresponding to the connection information, the state information including last processed byte information and last byte forwarded information;
if the byte offset information is an expected byte offset from the last processed byte information, searching the received data packet for the at least one pattern; and
if the byte offset information is not the expected byte offset from the last processed byte information, forwarding the received data packet to a receiving process without searching the at least one pattern.

2. The method of claim 1, further comprising the step of, if the at least one pattern is found, dropping the received data packet.

3. The method of claim 1, further comprising the step of, if the byte offset information is an expected byte offset from the last processed byte information and if the at least one pattern is found, saving the byte offset information as the last processed byte information.

4. The method of claim 1, further comprising the step of, if the byte offset information is not the expected byte offset from the last processed byte information, copying the data packet and saving the byte offset information as the last byte forwarded information.

5. The method of claim 1, further comprising the steps of:
checking if there is any saved data packet;
if there is a saved data packet, searching the saved data packet for the at least one pattern;
if the at least one pattern is not found, forwarding the received data packet; and
if the at least one pattern is found, dropping the received data packet.

6. The method of claim 5, further the step of, if the at least one pattern is not found, forwarding the received data packet further comprising the step of saving a byte offset information on the saved data packet as the last processed byte information.

7. The method of claim 1, further comprising the step of checking if there is a connection corresponding to the connection information in a connection table.

8. The method of claim 7, further comprising the step of creating a connection entry in the connection table if there is no connection corresponding to the connection information.

9. An apparatus for searching predefined at least one pattern in data packets received from a data network, comprising:
a receiving unit for receiving a data packet from a data network, the data packet being identified with a connection;
a storage unit for storing state information for the connection;
a processing unit capable of
retrieving data information from the received data packet, the data information including byte offset information and connection information;
retrieving the state information corresponding to the connection information, the state information including last processed byte information and last byte forwarded information;
if the byte offset information is an expected byte offset from the last processed byte information, searching the received data packet for the at least one pattern; and
if the byte offset information is not the expected byte offset from the last processed byte information, forwarding the received data packet to a receiving process without searching the at least one pattern.

10. The processing unit of claim 9, further being capable of, if the at least one pattern is found, dropping the received data packet.

11. The processing unit of claim 9, further being capable of, if the byte offset information is an expected byte offset from the last processed byte information and if the at least one pattern is found, saving the byte offset information as the last processed byte information.

12. The processing unit of claim 9, further being capable of, if the byte offset information is an expected byte offset from the last processed byte information and if the at least one pattern is found, saving the byte offset information as the last processed byte information.

13. The processing unit of claim 9, further being capable of
checking if there is any saved data packet;
if there is a saved data packet, searching the saved data packet for the at least one pattern;
if the at least one pattern is not found, forwarding the received data packet; and
if the at least one pattern is found, dropping the received data packet.

14. A computer-readable medium on which is stored a computer program for searching predefined at least one pattern in data packets received from a data network, the computer program comprising computer instructions that when executed by a computing device performs the steps for:
receiving a data packet from the data network;
retrieving data information from the received data packet, the data information including byte offset information and connection information;
retrieving a state information for a connection corresponding to the connection information, the state information including last processed byte information and last byte forwarded information;
if the byte offset information is an expected byte offset from the last processed byte information, searching the received data packet for the at least one pattern; and
if the byte offset information is not the expected byte offset from the last processed byte information, forwarding the received data packet to a receiving process without searching the at least one pattern.

15. The computer program of claim 14, further performing the step of, if the at least one pattern is found, dropping the received data packet.

16. The computer program of claim 14, further performing the step of, if the byte offset information is an expected byte offset from the last processed byte information and if the at least one pattern is found, saving the byte offset information as the last processed byte information.

17. The computer program of claim 14, further performing the steps of:
checking if there is any saved data packet;
if there is a saved data packet, searching the saved data packet for the at least one pattern;
if the at least one pattern is not found, forwarding the received data packet; and
if the at least one pattern is found, dropping the received data packet.

18. The computer program of claim 17, further comprising the step of, if the at least one pattern is not found, forwarding the received data packet further comprising the step of saving a byte offset information on the saved data packet as the last processed byte information.
